(19) United States
(12) Patent Application Publication
(10) Pub. No.: US 2010/0259619 A1
(43) Pub. Date: Oct. 14, 2010

(54) HMD WITH ELEVATED CAMERA

(76) Inventor: Timothy J. Nicholson, Fort Myers, FL (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/758,685

(22) Filed: Apr. 12, 2010

Related U.S. Application Data
(60) Provisional application No. 61/168,494, filed on Apr. 10, 2009.

(51) Int. Cl. H04N 7/18

(52) U.S. Cl. 348/158; 348/E07.085

(57) ABSTRACT

A viewing system displaying images to a viewer from a camera capable of being elevated. Specifically, a head mounted display for displaying images from a camera that can be elevated. The viewing system can be mounted to the viewer's head so that the rotation of the viewer's head will rotate the camera and the image displayed. The head mount can also position the display in front of the viewer's eyes to allow for hands free viewing. An extendable shaft is also attached to the head mount and supports the camera affixed a top the shaft that elevates the camera to the desired elevation. The camera can communicate images captured by the camera to the head mounted display via a wired or wireless connection.

This application claims the benefit of priority based on U.S. Provisional Application No. 61/168,494, filed on Apr. 10, 2009, the disclosure of which is incorporated herein by reference in its entirety.

### FIELD OF THE DISCLOSURE

The present invention is generally related to viewing systems having a camera transmitting images to a display. Specifically, the present invention is related to viewing systems having a camera capable transmitting images while elevated.

### BACKGROUND OF THE DISCLOSURE

Individuals can encounter circumstances require a viewing system to gain an elevated view of a situation or location. These circumstances can include gaining a view of the situation to provide a different perspective than available at eye level or to view a situation or location over obstructions. However, the displayed view can have to be re-orientated to follow an ongoing situation, as a single fixed view can be insufficient to capture a changing or unfolding view. Furthermore, viewers can wish to have their hands free while operating the viewing system to perform other tasks such as recording information about the situation by hand.

Short of climbing to achieve the elevated view, these circumstances are commonly resolved using a single elevated mirror or a plurality of mirrors to reflect light from an elevated position to the viewer's eyes. While simple in concept, mirror systems require precise orientation of the mirrors relative to each other to correctly reflect the light to the viewer's eye without distorting the view. As a result, such known mirror systems often include heavy or unwieldy casings to hold the mirrors in the correct orientation and spacing relative to each other. Typically, mirror systems are either hand held or mounted in a fixed location to compensate for the heavy or unwieldy casings. Consequently, hands free operation of mirror systems is typically impossible. In addition, because the casings hold the mirrors at a constant spacing, the mirror systems often cannot be collapsed or broken down for easy transport.

The performance requirements of mirror systems further reduce the applicability of mirror systems for many situations. Mirrors can cause the viewed object to appear further away than in reality or only present a narrow view of the situation limited by size of the mirrors. In addition, a single damaged or dirty mirror in a plurality of mirrors can obscure the view provided by the mirror system or render the system inoperative.

A camera system can be disposed at the viewer's end of a mirror system to correct some of the performance problems of traditional mirror systems and to add additional features, such as zoom. However, these combined systems still require heavy or unwieldy casings to orientate the mirrors and as a result suffer from many of the same drawbacks as simple mirror systems. Consequently, the combined systems still require users to orientate the system by hand and are often difficult to move and setup.

An alternative solution is mounting a camera on a fixed or telescoping stand that elevates the camera to the desired elevation. Typically, the stands are either mounted on the ground with a stabilizing base or hand held. While camera stands alleviate many of the inherent deficiencies of mirror systems, camera stands still suffer from many of the same problems as mirror systems. Camera stands with stabilizing bases are often heavy in order to provide the sufficient support for the elevated camera, but as a result cannot be quickly orientated on a situation or re-orientated to follow a changing situation. Similarly, hand-held stands are often unwieldy with a high center of mass and require considerable skill on the part of the viewer to balance the camera at the top of the stand while orientating the camera toward the desired situation. Variations on camera stands include mechanical mounts for the camera that can be controlled to orientate the camera at the desired target independent of the camera stand's orientation. However, such mechanical mounts often require complex controls and considerable skill on the part of the viewer to effectively follow the ongoing situation. In addition, the mechanical mounts add considerable weight and complexity to the stand making the stand even less portable and more difficult to setup.

From the forgoing, it can be seen that a need exists for a viewing system that is lightweight and easily portable, yet is capable of providing the necessary elevated view. In addition, the viewing system should be capable of being quickly re-orientated to follow an ongoing or changing situation.

### SUMMARY OF THE DISCLOSURE

The present disclosure provides a viewing system displaying images from a camera capable of being elevated. More specifically, the present disclosure teaches the use of a head mounted display for displaying images from a camera worn by a person that can be elevated above and separated from the head at least 6 inches and preferably 1 foot or more. Generally, the viewing system can comprise a head mount, a display, a support portion, such as a shaft, and a video camera. The head mount can secure the viewing system to the viewer's head, whereby the rotation of the viewer's head will also rotate the camera and provide a different image. The head mount can also position the display in front of the viewer's eyes to allow for hands free viewing of images captured by the camera. The support portion, such as a shaft can also be attached to the head mount and supports the camera affixed to the top of the shaft. The camera can communicate images captured by the camera to the head mounted display via a wired or wireless connection. Alternatively the shaft can extend from other devices worn by the user, such as a backpack.

In another aspect, the present disclosure is directed to a viewing system in which the support portion is capable of extending and retracting to set the camera at different elevations. The shaft can be capable of retracting so that the camera is not elevated above eye level to provide the user with the features of the camera at eye level, such as zoom. The head mount or other worn device can further comprise a mechanical means for extending or retracting the shaft. For example, the mechanical means for elevating the camera can comprise a telescoping mechanism or a scissor mechanism. Similarly, the head mount can further comprise a mechanical means for rotating the shaft and camera to provide a 360 degree view from the elevated position as well as tilting the camera.

In another aspect, the present disclosure is directed to a viewing system further comprising a controller for controlling the functions of the camera and the elevation or rotation of the camera. The controller can be hand held, belt mounted, or wrist mounted and capable of communicating with the camera wirelessly or via a wired connection. The controller allows the viewer to adjust the image that is communicated to the display, such as the zooming or applying a light filter to the image. The controller can further comprise storage media for the camera and other camera elements to reduce the weight of the portion of the camera at the top of the shaft. The controller can also comprise a power source for the viewing system to reduce the weight on the viewer's head and reduce the unwieldiness of the camera. The controller can also control motion mechanisms associated with the elongate support, for elevation, direction, angle from horizontal.

In another aspect, the present disclosure is directed to a viewing system in which the camera can be selected from a variety of light weight cameras having different features. For example, cameras capable of panoramic views, cameras having infrared or ultraviolet filters, cameras with a zoom function and cameras having other photographic or video functions can be affixed to atop the shaft.

In another aspect, the complete camera or only the optical and sensor portions of the camera can be placed atop the support portion with the remainder of the camera being disposed on the head mount or within the controller. By placing the only the optical and sensor portions of the camera atop the elongate member, the overall weight of the camera at the top of the elongate member is reduced thereby reducing the unwieldiness of the viewing system and the strain on the viewer's head

An object of the present invention is to provide a simple light weight viewing system capable of rapid deployment and that is easily portable. The present invention is completely mounted on the person of the viewer and capable of moving with the viewer or as controlled by the viewer. Once mounted on the viewer, the viewing system does have to be setup again if the viewer chooses to move. Instead, the viewing system is capable of streaming live images even while the viewer is moving. In addition, as the shaft in some aspects can be retractable, the viewer is capable of moving through tight spaces without removing the viewing system simply by retracting the shaft.

An object of the present invention is to provide an elevated camera that is responsive to the natural head movements of the viewer rather than a set of complex controls that must be manipulated by the viewer. By mounting the camera to the viewer's head and providing a head mounted display, the viewer can control the image displayed using the viewer's natural body movements. The rotation of the viewer's head will cause a corresponding rotation in the camera's orientation and allowing the user to follow the situation as if the user was viewing the situation at eye level unaided by a viewing system.

In an embodiment where the elongate camera support extends forma worn device other than the head mounted device, the rotation of the camera can also be linked to head movements and can exaggerate such movements. A feature and advantage is that such a system allows 360° movement by the user with reduced or no head movement. In hunting scenarios this offers a very distinct advantage.

### BRIEF DESCRIPTION OF THE FIGURES

The invention can be more completely understood inconsideration of the following detailed description of various embodiments of the invention in connection with the accompanying drawings in which:

FIG. 1 is a perspective view of the viewing system according to an embodiment of the invention.

FIG. 2 is a perspective view of a viewing system according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

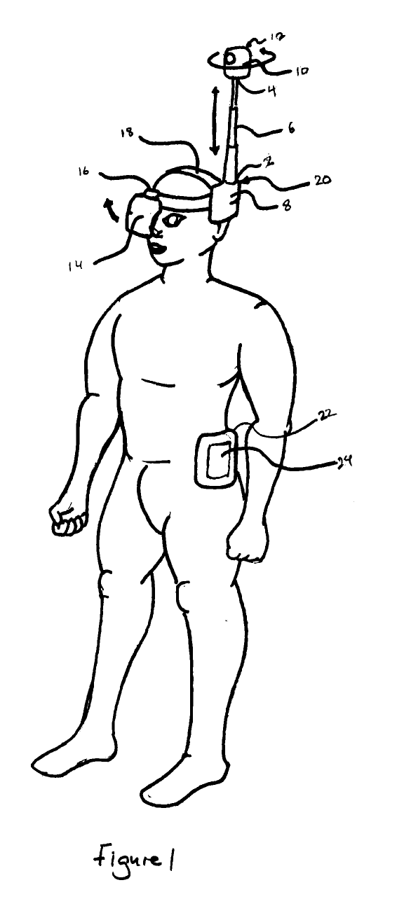

As illustrated in FIG. 1, the viewing system 20 generally comprises a camera portion 12, a display 14, and a head mount 18. The viewing system 20 can further comprise a control unit 22. The camera portion 12 further comprises a camera 10, a shaft 6 having a proximate 2 and a distal 4 ends, and a mechanical actuator 8. The display 14 further comprises a mechanical joint 16. U.S. Pat. No. 7,062,796 illustrates a head mounted display with a camera attached for swimmers. Said patent is incorporated by reference.

The display 14 is rotatably affixed to head mount 18 via the mechanical joint 16 so that when the head mount 18 is placed on the viewer's head, the display 14 can be presented to the viewer's eye. The display 14 can be capable of only covering one of the viewer's eyes or capable of covering both of the viewer's eyes. The mechanical joint 16 allows the display 14 to be lowered in front of the viewer's eyes when the viewing system 20 is in operation or lifted to provide the viewer with an unobstructed view.

The mechanical actuator 8 of the camera portion 12 is affixed to the head mount 18 so that the mechanical actuator 4 is disposed at the side or back of the viewer's head when the head mount 18 is placed on the viewer's head. The shaft 6 is in operational contact with the mechanical actuator 8 at the proximate end 2 whereby the shaft 6 can be rotated axially by the mechanical actuator 8. The camera 10 is affixed to the end distal end 4 of the shaft 6 and capable of being rotated with shaft 6 when the shaft 6 is rotated by the mechanical actuator 8. The shaft 6 can be capable of being extended or telescoped to different elevations by the mechanical actuator 8 or manually by the viewer. According to one embodiment of the invention, the shaft 6 is adapted to elevate the camera 10 at least one foot a viewer's head. According to another embodiment of the invention, the shaft 6 is adapted to elevate the camera 10 between about one and four feet above the viewer's head. According to yet another embodiment of the invention, the shaft 6 is adapted to elevate the camera 10 between about one and three feet above the viewer's head.

The control system 22 can be disposed somewhere on the viewer's person including the viewer's head or hand held. In the illustrated embodiment, the control system 22 is disposed the viewer's belt. The control system 22 further comprises a viewer interface 24 allowing the viewer to control the functions of the viewing system 20. The control system 22 is capable of controlling the mechanical actuator 8 to adjust the disposition and orientation of the camera 10. In addition, the control unit 22 can also be capable of controlling the images displayed by the display 14 and the various functions of the camera 10. The control unit 22 can further comprise parts of the camera 10 such as the storage media and the power supply to reduce the weight of the camera 10 on the shaft 6 and the viewer's head. The control unit 22 can be adapted to record images or video on the storage media and replaying the images or video via the display 14. Similarly, the control unit 22 can further comprise a power supply for the entire viewing system 20.

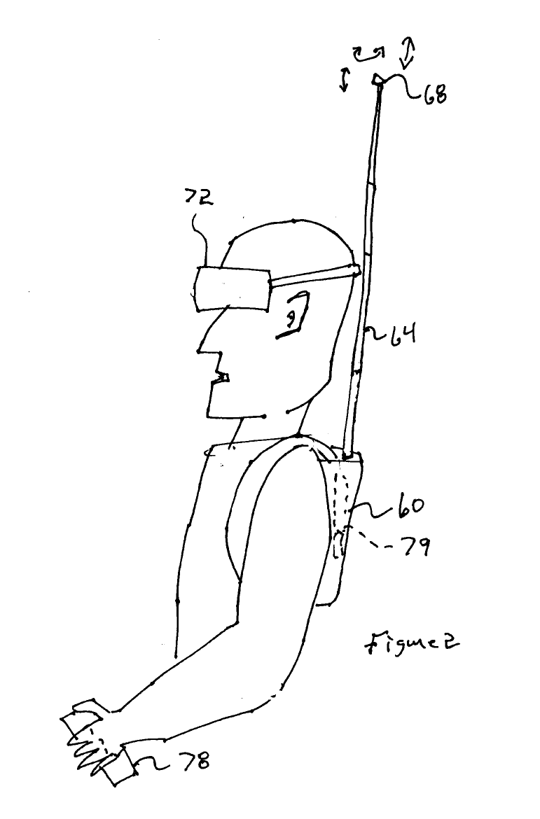

Referring to FIG. 2, a separately worn article, such as a backpack 60 provides a support for the elongate support member 64 that supports the camera 68. The head mounted display 72 can be wirelessly connected. A separate control 78 can operate the camera as well as positioning mechanisms 79, for example rotation mechanisms, tilting mechanisms, and elevation mechanisms that can be in the back pack. The display 72 can have sensors to detect rotation or tilting of the head to translate said motion to the positioning mechanisms of the camera. Such positioning mechanisms can be similar to the disclosure of U.S. Publication No. 2003/0161622. The 2003/0161622 publication is incorporated herein by reference.

In a further embodiment, the head mounted display can receive rf signals relating to a spectator event, for example a golf event. Such signals could be audio and/or visual.

The display 14, mechanical actuator 8, camera 10 and control system 22 can further comprise wireless communication systems such as radio, Bluetooth or other wireless communicating systems. The wireless communication systems allows for wireless control of the viewing system 20 and the wireless transmission of images from the camera 10 to the display 14.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

What is claimed:

1. A head mounted viewing system, comprising:
a camera adapted to capture and transmit at least one image;
a head mount for mounting the camera on a user's body, wherein the head mount orients the camera based on the position of the user's body;
a display adjustably affixed to the head mount and for receiving and projecting at least one image transmitted by the camera, wherein the display is positioned on the head mount so as to project images to the user; and
an extendable support operably linking the camera to the head mount and adapted to move the camera to a plurality of elevations.

2. The head mount viewing system of claim 1, further comprising:
an actuator affixed to the camera and adapted to orient the camera independently of the position of the user's body;
a controller operably linked to the actuator for adjusting the orientation of the camera.

3. The head mount viewing system of claim 1, wherein the controller is operably linked to the extendable support and adapted to adjust the elevation of the camera.

4. The head mount of claim 1, wherein
the camera further comprises a wireless transmitter for wirelessly transmitting the captured images, and
the transmitter further comprises a wireless receiver for wirelessly receiving the transmitted captured images.

5. The head mount of claim 1, wherein the camera further comprises a filter selected from the group consisting of infrared filters and ultraviolet filters.

6. The head mount of claim 1, wherein the camera further comprises a wide viewing lens for capturing at least one panoramic image.

7. The head mount of claim 1, wherein the camera further comprises:
an optical portion for capturing at least one image, wherein the optical portion is oriented based on the position of the user's body and moved by the extendable support; and
a transmitting portion operably linked to the optical portion and mounted to the user's body for transmitting the captured image.

8. The head mount of claim 1, wherein the extendable support elevates the camera between about 1 foot and about 4 feet above the user's head.

9. The head mount of claim 1, wherein the extendable support elevates the camera at least about 1 foot above the user's head.

10. The head mount of claim 1, further comprising a memory unit adapted to record at least one image transmitted by the camera and playback the images to the display for projecting the recorded image to the user.

11. A method for elevated viewing, comprising:
mounting a camera on a user's body;
positioning the camera in a first orientation, wherein the first orientation corresponds to a first position of the user's body;
elevating the camera to a first elevation;
capturing a first image on the camera at the first elevation;
transmitting the first image to a display, wherein the display is adapted to present images to the user; and
presenting the first captured image to the user.

12. The method of claim 9, further comprising:
capturing a video on the camera;
transmitting the video to the display; and
presenting the video to the user.

13. The method of claim 9, further comprising:
repositioning the camera to second orientation corresponding to a second position of the user's body;
capturing a second image at the second orientation; and
presenting the second image to the user.

14. The method of claim 9, further comprising:
elevating the camera to a second elevation;
capturing a second image at the second elevation; and
presenting the second image to the user.

15. The method of claim 9, further comprising:
mounting the camera on an actuator for orienting the camera independently of the position of the user's body;
remotely manipulating the actuator position the camera in a second orientation;
capturing a second image at the second orientation; and
presenting the second image to the user.

16. The method of claim 9, further comprising:
capturing at least one image through a filter selected from the group consisting of infrared filters and ultraviolet filters; and
presenting the filtered image to the user.

17. The method of claim 9, further comprising:
capturing a panoramic image; and
presenting the panoramic image to the user.

18. The method of claim 9, further comprising:
elevating the camera between about 1 foot and about 4 feet above the user's head.

19. The method of claim 9, further comprising:
elevating the camera at least 1 foot above the user's head.

20. The method of claim 11, further comprising:
recording at least one image;
transmitting the recorded image to the display; and
presenting the recorded image to the user.
